(19) United States
(12) Patent Application Publication
(10) Pub. No.: US 2002/0106070 A1
(43) Pub. Date: Aug. 8, 2002

(54) Technique for effectively capturing and processing event data

(76) Inventors: Nicholas J. Elsey, West Linn, OR (US); Neil E. Isenberg, Portland, OR (US); Timothy A. Timmins, Tigard, OR (US)

Correspondence Address: Alex L. Yip, Kaye, Scholer, Fierman, Hays & Handler, LLP, 425 Park Avenue, New York, NY, 10022, US

(21) Appl. No.: 09/777,061

(22) Filed: Feb. 5, 2001

Related U.S. Application Data
(60) Provisional application No. 60/244,086, filed on Oct. 27, 2000.

(51) Int. Cl. H04M 3/42

(52) U.S. Cl. 379/218.01; 379/221.01

(57) ABSTRACT

In a call center where information assistance calls are received, an operator may provide different services to a customer in each call. Such services may include, e.g., searches for a desired telephone number, regional restaurant, etc. Thus, multiple events, e.g., the telephone number and regional restaurant search events, may occur during the same information assistance call. In accordance with the invention, an event monitor server is connected to different clients in the center which generate records concerning the events occurring during the call. The server is used to collect such event records from the clients. The collected records are transmitted through a communications network to a remote computer for their analysis. To effectively utilize the limited bandwidth of the communications network, the event monitor server may compress the data in the event records before its transmission. It may also transmit the event record data in accordance with a data throttling scheme in response to a measured transmission latency. In addition, it may prioritize the event records to be transmitted, and filter out unwanted records before transmission thereof. After the transmitted event records are received, additional event records may be generated based on selected, received event records. Summary tables may also be formed which facilitate analysis of event data.

This application claims priority of U.S. Provisional Application No. 60/244,086 filed on Oct. 27, 2000 under 37 U.S.C. § 119(e).

### FIELD OF THE INVENTION

The invention relates to a data collection and processing technique, and more particularly to a technique for capturing and processing data concerning events such as those occurring during a communication, e.g., information assistance calls.

### BACKGROUND OF THE INVENTION

It is a common experience to call a telephone operator for information assistance. In a typical information assistance call, a customer identifies to the operator the name and address of a party whose telephone number is desired. In response, the operator locates the desired destination number using, e.g, a computer database. The destination number is then provided to the customer, e.g., by a computerized voice response unit (VRU) which provides a synthesized voicing of the number, and the customer is afforded an option to be connected to the destination number without the need of first terminating the information assistance call.

In the event that the connection to the destination number is made for the customer, the operator may stay on the line as a conferenced party so as to provide further assistance. Alternatively, in a “StarBack” service which is described in U.S. Pat. No. 5,797,092 issued Aug. 18, 1998 to Cox et al., the connection may be continually monitored for a predetermined DTMF signal, such as that obtained by pressing “*” button, issued by the customer. If such a signal is detected, the customer is transferred back to an operator, who can then provide further assistance.

Additional services may be provided in an information assistance call. For example, upon request, an operator may also provide a customer with information on regional restaurants, movie listings, and directions to various places, etc. Thus, during an information assistance call, multiple events may occur which include, e.g., a destination number connection event, StarBack event, restaurant search event, movie inquiry event, directions inquiry event, etc.

In prior art, for marketing analysis and other reasons, statistics concerning information assistance calls is compiled based on call detail records (CDRs) generated by a switch system at a call center. However, the information provided by the CDRs is limited to a tally of the calls handled by the operators at the center, and the length of each call. The compilation of the statistics is also based on data concerning any of the aforementioned events which occur during a call. The collection of such data relies on the cooperation of all of the operators who are required to manually record the events during each call. However, the resulting statistics is subject to error as the manual recording may be based on the operators' recollection of the events during a call and is thus unreliable, especially when the operators are busy handling calls having many events therein.

Thus, it is desirable to have a system and method for effectively capturing and processing data concerning the call events to yield accurate statistics thereof.

### SUMMARY OF THE INVENTION

The invention overcomes the prior art limitations by using, among others, an event monitor server to collect and process data concerning events. We have recognized that the application of the invention is not limited to events which occur during communication calls. Rather, the invention generally applies to any events or occurrences which may be described and/or identified by data, and which may occur during transactions, inquiries, transmissions, etc. In addition, events may be generated based upon other events.

By way of example, but not limitation, the event monitor in accordance with the invention is used in a call center to collect and process data concerning events which occur during communication calls. The event monitor server is connected to clients, e.g., the aforementioned VRU and switch system, in the call center. Each client automatically generates an event record when it is used in handling the call, thereby realizing an event whose description is included in the event record. In addition, the event records concerning the events realized in the same call each include an identifier identifying the call.

After collecting the event records from the clients, the event monitor server transmits the data in the records through a communications network to a remote computer for manipulation and analysis of the data, thereby yielding accurate statistics concerning the events. To effectively utilize the limited bandwidth of the communications network, in accordance with an aspect of the invention, the event monitor server performs data compression on the event data before its transmission. In addition, in response to a substantial transmission latency, the server may control the rate at which the event data is transmitted by implementing a data throttling scheme. In the event of a loss of a connection to the remote computer, the server causes the event data to be stored in a memory, e.g., a cache, until the connection is reestablished. At such time, transmission of the event data from the cache resumes. Moreover, priority may be accorded to selected event records concerning, e.g., a particular event type. Accordingly, the data in the event records having a relatively high priority status is transmitted ahead of the data in those having a relatively low priority status. Further, the server may filter out unwanted event records before their transmission based on selected data values in the records.

In accordance with another aspect of the invention, the functions of the event monitor server, e.g., the aforementioned data compression and throttling functions, are realized based on specified parameters in a configuration file. Advantageously, these functions can be flexibly modified and implemented by easily changing the parameters in the file.

In accordance with yet another aspect of the invention, after the remote computer receives the event records from the event monitor server, data in the received records is inserted into a database. Additional events are identified based on selected data being inserted into the database. Event records representing the additional events are then generated.

In accordance with still yet another aspect of the invention, in compiling statistics concerning at least one communication call, selected ones of the received records are associated with the communication call based, e.g., on an identifier in the selected records which identifies the communication call. Statistics concerning the communication call is then generated based on data in the selected records.

### BRIEF DESCRIPTION OF THE DRAWING

Further objects, features and advantages of the invention will become apparent from the following detailed description taken in conjunction with the accompanying drawing showing an illustrative embodiment of the invention, in which:

FIG. 1 is a block diagram of a call center in accordance with the invention which receives information assistance calls;

FIG. 2 illustrates a record concerning an event which occurred during an information assistance call;

FIG. 3 illustrates an arrangement wherein an event monitor server collects event records in the call center of FIG. 1 and transmits the records to a remote computer in accordance with the invention;

FIG. 4 is a flow chart depicting a process whereby the event monitor server collects and transmits the event records to the remote computer;

FIG. 5 is a flow chart depicting a routine for auto-generating event records based on other event records in accordance with the invention;

FIG. 6 illustrates a first table for summarizing data from event records in accordance with the invention;

FIG. 7 illustrates a second table for summarizing data from event records in accordance with the invention;

FIG. 8 illustrates a table which is used to help develop summarization data in the table of FIG. 7; and

FIG. 9 is a flow chart depicting a routine for developing the summarization data in the table of FIG. 7.

### DETAILED DESCRIPTION

The invention is directed to collecting and processing data concerning events. In general, events are occurrences which may be described and/or identified by data, and which may occur during communication calls, transactions, inquiries, transmissions, etc. In addition, events may be generated based upon other events.

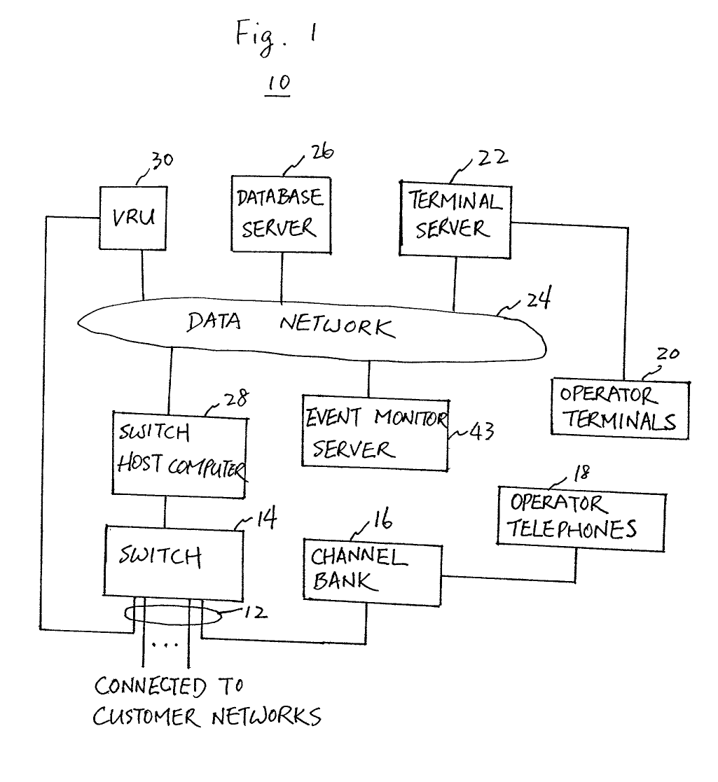

In this illustrative embodiment, the events in question occur during communication calls, e.g., information assistance calls. FIG. 1 illustrates call center 10 embodying the principles of the invention which receives information assistance calls. As shown in FIG. 1, call center 10 includes switch 14 having T1 spans 12 for connection to voice response unit (VRU) 30, channel bank 16 and customer networks. Channel bank 16 is used to couple multiple operator telephones 18 to switch 14. The operators in center 10 are further equipped with operator terminals 20, each of which includes a video display unit and a keyboard with associated dialing pad. Operator terminals 20 are coupled to terminal server 22, which in turn is connected over data network 24 to database server 26. Event monitor server 43 in accordance with the invention, switch host computer 28 and VRU 30 are also connected to data network 24. By way of example, data network 24 includes a local area network (LAN) supplemented by a number of point-to-point serial data links.

Call center 10 may receive an incoming information assistance call from one of the customer networks through a carrier switching center in the network. It also places outgoing calls through one of the customer networks which may be different than that used for the incoming call.

Switch 14 is conventional which includes digital signal processing circuitry which provides the requisite conference capability and dual tone multi-frequency (DTMF) and multi frequency (MF) tone generation/detection capabilities. In this illustrative embodiment, switch 14 supports digital T1 connectivity. The operation of switch 14 is governed by instructions stored in switch host computer 28.

Each incoming information assistance call from a customer is received by switch 14 in center 10 which connects it to an available operator's telephone. If no operator is available when a call is received, the call is queued in a conventional manner until an operator becomes available.

Terminal server 22 serves as an interface between serial devices, such as operator terminals 20 and data network 24, allowing the terminals to login as devices on the network. Operators may utilize database server 26 to provide information assistance including searching for a customer's desired party and determining the appropriate destination number of the party. The destination number is then provided to the customer via VRU 30 which provides a synthesized voicing of the number, and the customer is afforded an option to be connected to the destination number without the need of first terminating the information assistance call.

VRU 30 is used to play the constant repeated parts of an operator's speech, namely, the various greetings and signoffs (or closings). VRU 30 is connected via data network 24 to switch host computer 28 and via one or more T1 spans to switch 14. At appropriate stages in a call progression, switch host computer 28 initiates a voice path connection between VRU 30 and switch 14 such that the caller, or the caller and the operator, are able to hear whatever pre-recorded speech is played on that connection by VRU 30. Computer 28 then instructs VRU 30, via data network 24, what type of message to play, and passes data parameters that enable VRU 30 to locate the message appropriate to the call state.

Let's assume that during an information assistance call a customer selects the option to be connected to the destination number located by an operator. In accordance with a well known “StarBack” service, switch 14 continually monitors such a connection for a predetermined DTMF signal, such as that obtained by pressing “*” button, issued by the customer. If such a signal is detected, the customer is transferred back to an operator, who can then provide further assistance. If the connection to the destination number results in ringing without answering, switch 14 instructs VRU 30 to present, in synthesized voice, a menu of options to the customer including, e.g., leaving a message for the non-answering party, continually calling the non-answering party every N minutes, paging the non-answering party, etc.

An operator may also utilize database server 26 to provide additional assistance including searching by type of goods/services and/or geographic region, thereby providing the customer with information on regional restaurants, movie listings, and directions to various places, etc. Thus, during an information assistance call, multiple events may occur which include, e.g., a destination number connection event, StarBack event, restaurant search event, movie inquiry event, directions inquiry event, etc.

In accordance with the invention, event monitor server 43 is used to capture event data generated by each client in center 10 (e.g., switch 14 and switch host computer 28, database server 26, or VRU 30 being one such client) when the client realizes the corresponding event. Thus, for example, when a customer calls for information assistance, and an operator is unavailable, the call is placed in queue by switch 14. At the same time, switch host computer 28 generates a first event record concerning the queuing event. When the call is ultimately connected to the operator by switch 14, computer 28 then generates a second event record concerning the operator connection event. If the customer asks the operator to search for restaurants in a particular area, given the customer's preferences, the operator utilizes database server 26 to locate such restaurants. Database server 26 then generates a third event record concerning the restaurant search event. Further, if the customer asks to be connected to the destination number of one of the located restaurants, the operator (a) determines the destination number using database server 26, which then generates a fourth event record concerning the determination of the destination number, and (b) initiating a call to the destination number through database server 26, which then generates a fifth event record concerning the call initiation. Accordingly, switch 14 connects the current information assistance call to the destination number, and computer 28 generates a sixth event record concerning the connection. If the connection results in ringing with no answer, VRU 30 presents the aforementioned menu options for selection by the customer, and generates a seventh event record concerning the menu presentation. If for any reason the customer utilizes the StarBack service to be re-connected to an operator, switch 14 generates an eighth event record concerning the StarBack event. As one can appreciate that as the information assistance call goes on, more and more events may occur and thus event records are generated during the call.

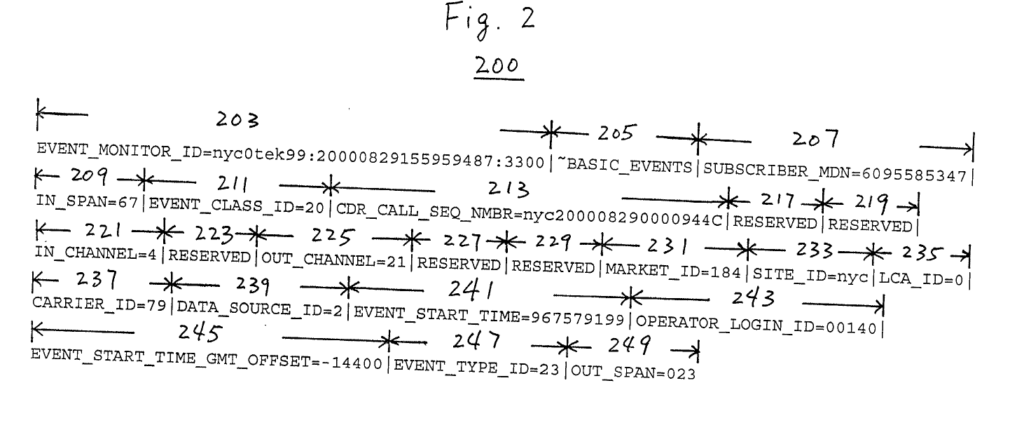

FIG. 2 illustrates one such event record, denoted 200, generated by a client during an information assistance call. As shown in FIG. 2, event records 200 includes multiple fields describing an event. Specifically, EVENT_MONITOR_ID field 203 identifies the event and is used to synchronize communications between the client generating the event record and event monitor server 43, and between server 43 and a daemon process running on a remote computer described below. For example, the value in field 203 “nycotek99:20000829155959487:3300” is used to identify record 200 in acknowledging receipt thereof in such communications. Field 205 identifies a table, e.g., Basic_Events table in this instance, which is maintained in the remote computer and into which selected data in record 200 is integrated. SUBSCRIBER_MDN field 207 identifies the telephone number of the customer who made the information assistance call. IN_SPAN field 209 identifies the T1 span transporting the incoming communication of the information assistance call. In this illustrative embodiment, each event is identified by an event type within an event class. EVENT_CLASS_ID field 211 specifies one of the event classes to which the instant event belongs. For example, the value “20” in field 211 in this instance corresponds to a CALL PROCESSING class. Other values for field 211 may correspond to, e.g., SEARCHES, VALUE ADDED SERVICE and LOCAL SERVICES classes. EVENT_TYPE_ID field 247 specifies one of the event types within the class identified by the value in field 211. For example, the value “231” in field 247 in this instance corresponds to a StarBack event within the CALL PROCESSING class. Similarly, other values for field 247 correspond to different types of event in an identified class.

CDR_CALL_SEQ_NMBR field 213 contains a sequence number identifying the information assistance call in question. It should be pointed out that event records concerning different events occurring in the same call share the same value in field 213. To this end, when the information assistance call is initially received by switch 14, switch host computer 28 assigns a sequence number identifying the call. It then generates and transmits a network message to each client connected to network 24, informing the client of use of the same sequence number to identify the current call.

Fields 217, 219, 223, 227 and 229 are reserved in this instance, which may be used to include more specific information concerning the event. IN_CHANNEL field 221 identifies the channel (within the T1 span identified by field 209 previously described) which the incoming communication of the information assistance call traverses. OUT_CHANNEL field 225 identifies the channel (within the T1 span identified by field 249 described below) which the outgoing communication of the information assistance call traverses. MARKET_ID field 231 identifies the carrier switch through which the information assistance call comes in. For example, the value “184” in field 231 identifies the carrier switch located at Boise, Id. in this instance. Thus, the information in field 231 also helps identify the geographic market using the information assistance service. Site_ID field 233 identifies the site of the call center receiving the information assistance call. LCA_ID field 235 identifies any table containing number plan areas (NPAs), also known as “area codes,” which pertain to the local calling area from which the information assistance call comes. CARRIER_ID field 237 identifies the carrier used to connect the call. For example, the value “79” in field 237 identifies AT&T Corp. as the carrier in this instance. DATA_SOURCE_ID field 239 identifies the client which generates record 200. EVENT_START_TIME field 241 indicates the start time of the event in question. It should be noted that the value in field 241 corresponds to a UNIX “epoch” time, i.e., the number of seconds elapsed from Jan. 1, 1970. It should also be noted that had the event in question, i.e., the StarBack event, not been instantaneous, an EVENT_END_TIME field corresponding thereto would also be included in record 200 to account for the duration of the event. OPERATOR_LOGIN_ID field 243 identifies the operator handling the event. Field 245 alternatively states the start time of the event as an offset from the Greenwich Mean Time (GMT), which offset is “−14400” seconds in this instance. Field 247 is described previously. OUT_SPAN field 249 identifies the T1 span transporting the outgoing communication of the information assistance call.

In this instance, each event record is further formatted by the client generating the record in packet form by adding a header to the record. Such a header includes the destination address of event monitor server 43 to which the packet is routed. It also includes, e.g., an indicator indicating the amount of data in the record.

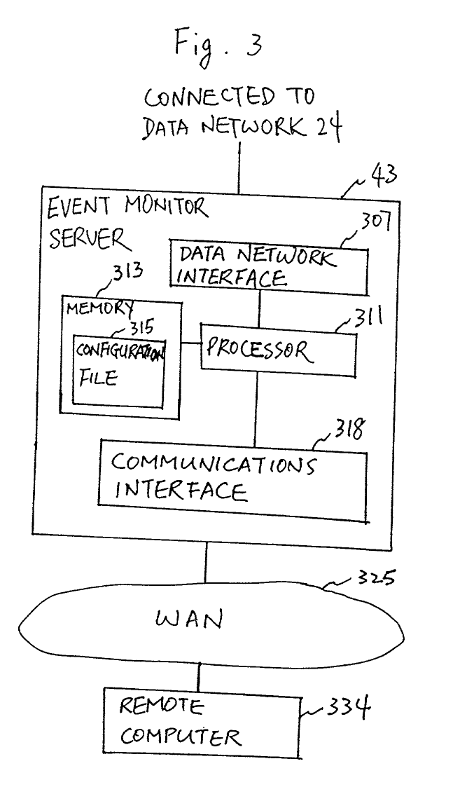

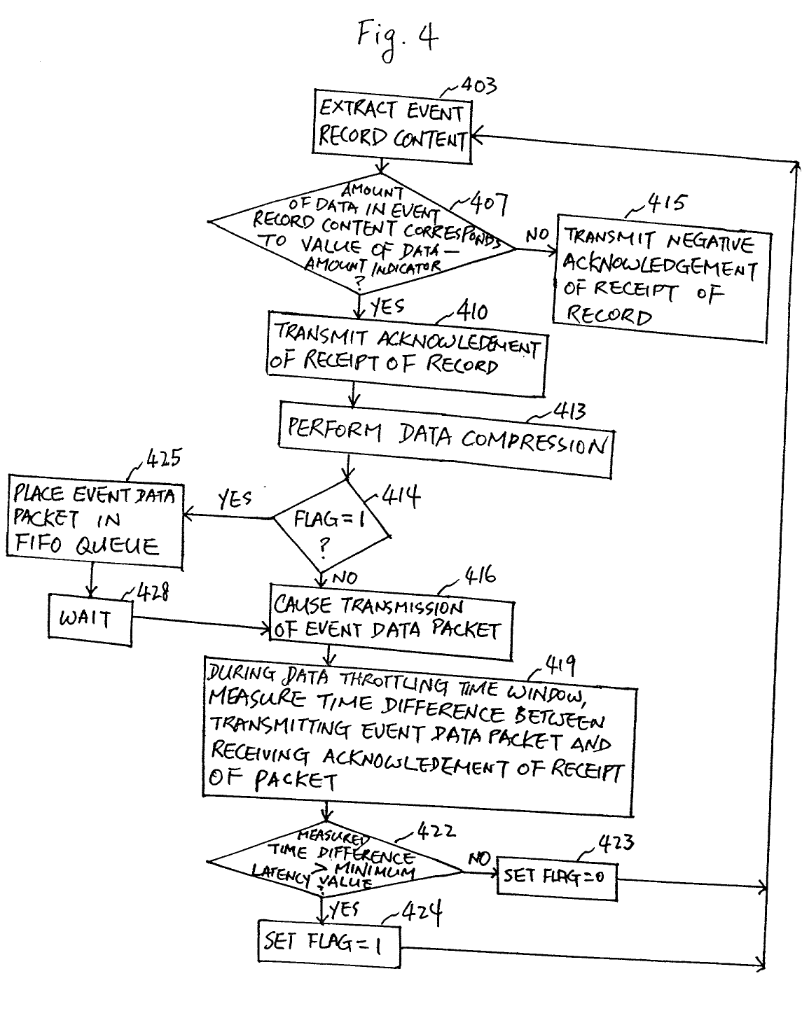

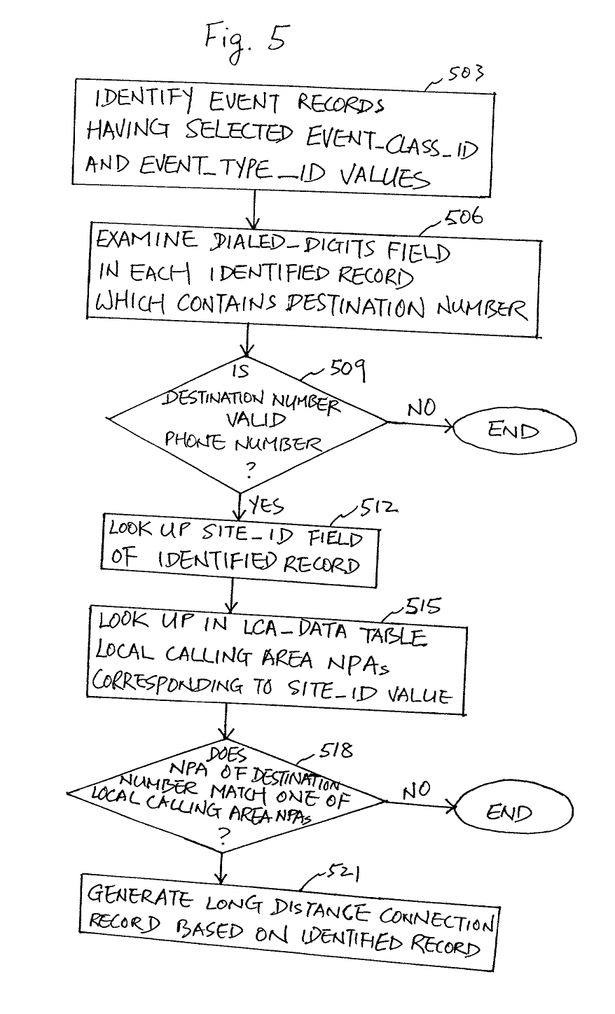

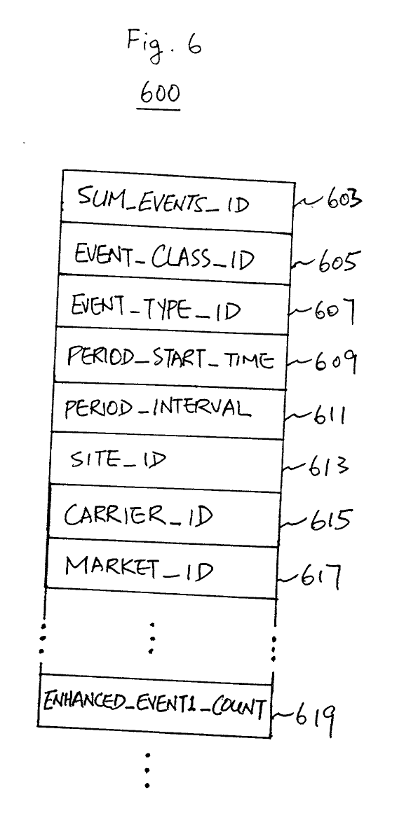

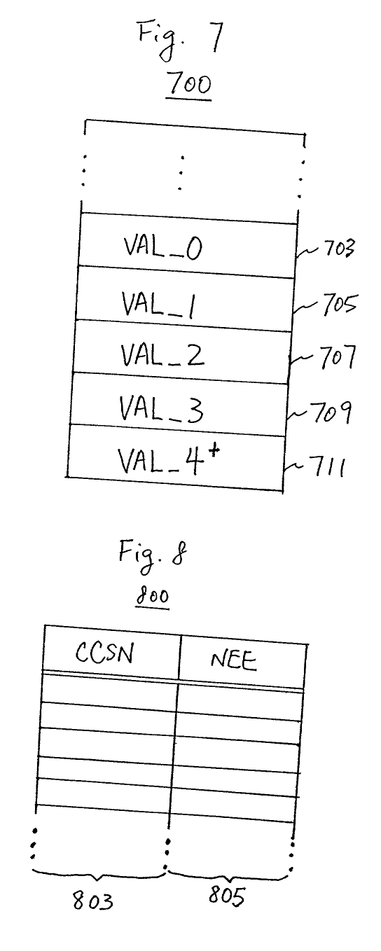

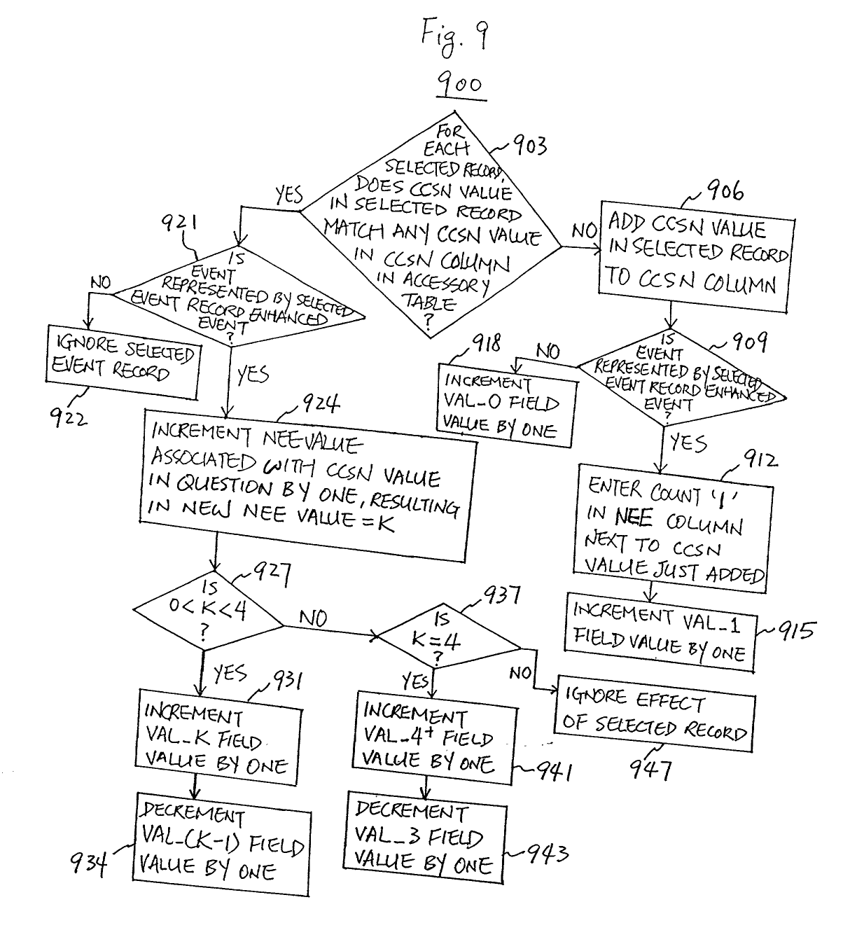

In a conventional manner, data network 24 routes each event record packet to server 43 based on the destination address therein. Referring to FIGS. 3 and 4, server 43 receives the event record packet through data network interface 307. Processor 311 extracts the event record content from the received packet, as indicated at step 403 in FIG. 4. Processor 311 at step 407 determines whether the amount of data in the event record content corresponds to the value of the data-amount indicator in the header. If the amount of the data corresponds to the indicator value, processor 311 assumes that the event record content is complete, and thus transmits an acknowledgment of receipt of the record identified by the EVENT_MONITOR_ID value in the record, as indicated at step 410. The subject routine then proceeds to step 413 described below. Otherwise, if the amount of data does not correspond to the indicator value, processor 311 assumes that the event record content is incomplete, and thus transmits a negative acknowledgment of receipt of the record, requesting retransmission of the event record packet, as indicated at step 415.

Event monitor server 43 further processes the data in the received event record to achieve effective communication of the data through a communication network, e.g., wide area network (WAN) 325, to remote computer 334 for manipulation and analysis of the data. To that end, processor 311 at step 413 performs compression of the event data before its transmission. For example, it translates selected terms in an event record which are frequently used to representations thereof which require less bandwidth to transmit. Such terms may include field names such as “SITE_ID,” “EVENT_CLASS,” etc. and table names such as “BASIC_EVENT” which frequently appear in an event record. A translation table containing the selected terms and the corresponding representations is stored in memory 313. In this illustrative embodiment, the representations used are numeric representations, e.g., 3-digit numerals. Memory 313 here generically includes disks, caches, and volatile and nonvolatile memories. The translation table is made part of configuration file 315 cached in memory 313. Configuration file 315 is further described below, it suffices to know for now that configuration file 315 contains information based on which event monitor server 43 is configured and operates.

Thus, in accordance with the aforementioned translation table, server 43 translates such terms as “BASIC_EVENT,” “SITE_ID, ” “EVENT_CLASS,” . . . in the event record to the corresponding 3-digit numerals to condense or compress the event data to be transmitted. Before transmission of the compressed event data, which is packetized pursuant to a predetermined protocol, processor 311 determines whether a FLAG is set to one, as indicated at step 414. This FLAG is initially set to zero and used to indicate whether the transmission of the event data packet to remote computer 334 should be controlled in accordance with a data throttling scheme described below. If FLAG=1, the subject routine proceeds to step 425 described below. Otherwise, if Flag=0, processor 311 causes transmission of the event data packet, which includes a destination address of remote computer 334, through communications interface 318, as indicated at step 416. Accordingly, the event data packet, albeit a copy thereof, is routed through WAN 325 to remote computer 334.

Although it is desirable to have event monitor server 43 forward the event data from call center 10 to remote computer 334 as quickly as possible, other event monitor servers in various call centers likewise forward the event data collected from those data centers to the same computer 334 through WAN 325, resulting in a competition for use of the limited bandwidth of WAN 325. Thus, during peak call times, data traffic from different event monitor servers may exhaust the capacity of WAN 325, thereby incurring a significant transmission latency.

To effectively handle such a latency, event monitor server 43 transmits the event data in accordance with the aforementioned data throttling scheme. To that end, the length of a data throttling time window and a minimum latency value are specified in configuration file 315. Based on such information in file 315, processor 311 defines a series of data throttling time windows of the specified length. During a data throttling time window, processor 103 measures the time difference, i.e., latency, between transmitting an event data packet and receiving an acknowledgment of receipt of the packet from remote computer 334, as indicated at step 419. Processor 311 at step 422 determines whether the measured time difference exceeds the minimum latency value specified in file 315. If it does not, processor 311 at step 423 sets Flag to zero, and the subject routine returns to step 403 previously described. Otherwise, if it does, processor 311 at step 424 sets FLAG to one, and the subject routine then returns to step 403.

Referring back to step 414, if it is determined there that Flag=1, processor 311 proceeds to step 425 where it places the event data packet to be transmitted in a first-in-first-out (FIFO) queue in memory 313 to slow down the rate at which the event data is forwarded to remote computer 334. The event data packet in the FIFO queue then enters a wait state as indicated at step 428 before its transmission at step 416. The waiting period for a packet in the FIFO queue may vary with the amount of latency measured. To that end, configuration file 315 may contain a second table for processor 311 to translate each latency amount to the corresponding waiting period. Thus, by looking up such a second table to prescribe appropriate waiting periods, processor 311 can effectively control the transmission data rate in response to different latency amounts.

In addition, if for any reason the connection between event monitor server 43 and remote computer 334 is lost, processor 311 caches all event data to be transmitted in memory 313 until the connection is reestablished. At such time, processor 311 resumes transmission of the event data from memory 313 to computer 334. A loss of the connection may be determined when processor 311 receives no signal from WAN 325, e.g., acknowledgment of receipt of any transmitted event data packet, within a predetermined time limit. Such a time limit may also be specified in configuration file 315.

It should be pointed out at this juncture that the use of configuration file 315 here is advantageous in that after the functions for event monitor server 43 are established, they can be flexibly implemented based on the parameters specified in file 315. For example, for the data compression function, when the need arises one can easily modify the terms and the corresponding representations in the translation table in file 315. Similarly, for the data throttling function, one can easily change the specifications of the data throttling time window size and/or the minimum latency value in file 315 to affect the data throttling scheme.

In addition, in accordance with an aspect of the invention, processor 311 may be programmed to perform a data filtering function, whereby selected event records are filtered out without further processing. For example, event records concerning selected carriers may be filtered out by processor 311 examining CARRIER_ID field 237 of each record. If field 237 of the record has one of the values corresponding to the selected carriers, processor 311 may disregard the record. The filter parameters, e.g., the identities of the fields and particular field values, based on which processor 311 screens out unwanted event records may be specified in configuration file 315 to facilitate changes in the parameters from time to time.

In accordance with another aspect of the invention, to more effectively utilize the limited bandwidth of WAN 325, priority of event records for transmission may be established. For example, the priority may be based on the particular event class and type of the records which are identified by the particular values in EVENT_CLASS_ID field 211 and EVENT_TYPE_ID field 247 of the records, respectively. To that end, combinations of EVENT_CLASS_ID and EVENT_TYPE_ID values corresponding to different event classes and types which are accorded priority are specified in configuration file 315. For each combination, a priority value, e.g., a high or low priority value, can also be specified in file 315. In accordance with such a priority specification, processor 311 arranges the order of event records to be transmitted. Each event record is assumed to be of normal priority unless the values in fields 211 and 247 of the record match one of the combinations specified in file 315. In that case, processor 311 reads the priority value associated with the matched combination to determine whether the record is accorded a high or low priority status. In this illustrative embodiment, processor 311 causes a high priority event record to be transmitted ahead of normal and low priority event records, and normal priority event records ahead of low priority event records.

In an alternative embodiment, the priority is specified in file 315 in terms of a weight value W relative to a predetermined weight for medium priority. By way of example, let's say the predetermined weight for medium priority is 10. In accordance with this priority scheme, processor 311 causes transmission of event records having a W priority weight ahead of medium priority event records in the proportion of W out of (W+10) times. For example, relatively high priority event records having W=20 are transmitted ahead of medium priority event records 20 out of 30 times, i.e., two out of three times. On the other hand, relatively low priority event records having, e.g., W=2 are transmitted ahead of medium priority event records 2 out of 12 times, i.e., one out of six times.

A daemon process runs on remote computer 334 and is used to receive event data packet from various call centers including center 10 through WAN 325. As is conventional, the daemon process is an agent program which continuously operates on computer 334 as a background process and performs system-wide functions. In this instance, these functions include de-packetizing the received packets to extract the event data contents therein. The daemon process also performs decompression of the event data according to a translation table inverse to the above-described translation table in configuration file 315. That is, it translates any representations of the terms used in the event record back to the original terms. It further inserts data from the recovered event records into a database, e.g., the aforementioned BASIC EVENT table, which may be an Oracle-type database. However, for effective analysis of the event data, other summary tables described below are formed. Queries may be formed against the database and summary tables to obtain useful information therefrom.

In accordance with another aspect of the invention, remote computer 334 is programmed to perform an auto-generation process for generating in real time event records, referred to as “child records”, based on selected ones of the recovered event records, referred to as “parent records”. As data from the recovered event records is being inserted in the aforementioned database, the auto-generation process identifies from the records any parent records which satisfy certain criteria, and generates the corresponding child records. The child records, thus generated, would be treated similarly to any other event record.

For example, one such child record generated by the auto-generation process in accordance with the invention is a “long distance connection” event record, which captures an event where a user is connected to a destination number through a call center, e.g., call center 10, via a long distance connection. Thus, such a long distance connection record may be derived from those event records which indicate that an outbound call, or a conference call was made through the call center, provided that such a call involves a long distance connection. To that end, instructed by a routine of the auto-generation process, computer 334 examines EVENT_CLASS_ID field 211 and EVENT_TYPE_ID field 247 of the event records being inserted in the database. Computer 334 identifies those event records having selected EVENT_CLASS_ID and EVENT_TYPE_ID values indicating that an outbound call or a conference call was made through a call center, as shown at step 503 in FIG. 5. In this instance, the identified records, which are potential parent records, each bear an EVENT_CLASS_ID value 20, and an EVENT_TYPE_ID value 14, 20 or 22. Computer 334 at step 506 examines a DIALED_DIGITS field (not shown) in each identified record which contains the destination number connected through the call center. Computer 334 at step 509 determines whether the destination number is a valid phone number. In a well known manner, in making such a determination, computer 334 checks whether the destination number consists of only numerals, and is in compliance with the standard telephone numbering plan. If it is determined that the destination number is not a valid phone number, the subject routine comes to an end. Otherwise, the routine proceeds to step 512 where computer 334 looks up the value in SITE_ID field 233 of the identified record which specifies the call center involved.

It should be pointed out at this juncture that an LCA_DATA table is maintained in a memory (not shown) of computer 334. This table provides number plan areas (NPAs), also known as “area codes”, of local calling areas for each call center specified by its site ID. Thus, any connection by the call center to a destination number having its NPA matching one of the local calling area NPAs associated with the call center is considered a local connection.

Continuing the above example, computer 334 at step 515 looks up in the LCA_DATA table the local calling area NPAs corresponding to the site ID value in the identified record. Computer 334 at step 518 determines whether the NPA of the destination number identified at step 506 matches one of the local calling area NPAs just looked up. If it is determined that the NPA of the destination number matches one of the local calling area NPAs, the subject routine comes to an end as the connection by the call center to the destination number is considered a local connection. Otherwise, if it is determined that the connection is a long distance connection, computer 334 generates a long distance connection event record based on the identified record, as indicated at step 521. Specifically, in this example computer 334 duplicates the identified record, and changes the EVENT_TYPE_ID value of the duplicate record to “24”, with EVENT_CLASS_ID value unchanged as, in this instance, the EVENT_CLASS_ID=20 and EVENT_TYPE_ID=24 jointly identify the newly-generated record as a long distance connection event record.

The routine of FIG. 5 similarly applies to autogeneration of another type of child record, namely, a “national search” event record. The auto-generation of a national search event record is different from that of FIG. 5 partly because of different types of parent record from which the national search event record depends. Thus, in auto-generating the national search event record, computer 334 identifies at step 503 those parent records representing a detailed listing search event by a call center, instead. If the destination number in any such parent record resulting from the search event corresponds to a long distance number, which may be determined by going through steps 506, 509, 512, 515 and 518 previously described, computer 334 determines that the search event in question also includes a national search event. Computer 334 then similarly generates a national search event record based on the parent record.

In addition, the routine of FIG. 5 may be readily modified to identify those outbound calls or conference calls which were connected by a call center to a special service, thereby auto-generating a “special service” event record. Examples of special services include services providing horoscope, weather, traffic, local event and movie information. To that end, a SPECIAL_CONNECTION table is also maintained in the memory of computer 334. This table lists all known phone numbers used by call centers for the special services. For example, after going through steps 503, 506 and 509, computer 334 in this instance checks the destination number in an outbound call event record or a conference call event record against the listed phone numbers in the SPECIAL_CONNECTION table. If the destination number matches one of the listed phone numbers in the table, say, the horoscope service number, computer 334 similarly generates a horoscope service event record based on the corresponding outbound call event record or conference call event record.

As mentioned before, summary tables are formed to summarize event data to facilitate analysis of the data. In this illustrative embodiment, one such summary table is referred to as a “SUM_EVENTS” table. In accordance with the invention, a SUM_EVENTS table tracks the statistics of the events of a given class and type which occur in a specified period having a predetermined interval, e.g., a 15 minute interval, and which may also originate from specified call centers, carriers and/or markets. FIG. 6 illustrates the format of one such SUM_EVENTS table, denoted 600. As shown in FIG. 6, table 600 includes SUM_EVENTS_ID field 603 containing an assigned value for identifying table 600. In this instance, table 600 concerns those event records having selected EVENT_CLASS_ID values specified in field 605, selected EVENT_TYPE_ID values specified in field 607, selected SITE_ID values as specified in field 613, selected CARRIER_ID values as specified in field 615, and selected MARKET_ID values as specified in field 617. In addition, the event records being considered are required to have an event start time, which is provided in field 241 of the records, within the period interval (e.g., 15 minutes) specified in field 611 from the period start time specified in field 609 (which is in date/time format). Event records meeting the above criteria are continually added to table 600 and then summarized. For example, ENHANCED_EVENT1_COUNT field 619 tallies the number of the event records in question and thus the specified events represented thereby. Other summarization data includes, e.g., statistics concerning the total duration, median duration and longest duration of the specified events.

Another summary table, referred to as a “SUM_CALLS” table, may be formed to track statistics concerning selected information assistance calls handled over a specified period. For example, the selected information assistance calls each may have at least one event of a given class and type occurring during the call, and may also originate from specified call centers, carriers and/or markets. As such, the format of a SUM_CALLS table is similar to that of a SUM_EVENTS table described above. However, the SUM_CALLS table differs from a SUM_EVENTS table in that summarization data in the former is generated on a call basis while summarization data in the latter is generated on an event basis. As discussed before, an information assistance call can include multiple events. Thus, for example, three “conference call” events defined by being of particular event class and event type causes the record count in a SUM_EVENTS table to be incremented by three, regardless of whether two or all of them occur in the same information assistance call. However, in that case, the corresponding call count of an analogous SUM_CALLS table would be incremented by only one. Thus, in generating the summarization data in a SUM_CALLS table, only those event records meeting the criteria specified in the table and also having different CDR_CALL_SEQ_NMBR (CCSN) values are considered. As mentioned before, the CCSN value in field 213 of an event record identifies the information assistance call in which the event represented by the record occurs, and event records attributed to the same call have the same CCSN value. Thus, in generating the summarization data in a SUM_CALLS table, a list is also compiled to keep track of CCSN values associated with the event records which have been considered. Any event record which bears one of the CCSN values in the list but otherwise satisfies all of the specified criteria in the table would be ignored as the corresponding call has been taken into account.

Yet another summary table, referred to as a “SUM_FREQCOUNT” table, may be formed to track the number of calls in which none or some “enhanced” events occurred. In this illustrative embodiment, an enhanced event is a selected event of particular interest. For example, the aforementioned STARBACK events, long distance connection events and national search events are designated enhanced events in this instance. FIG. 7 illustrates a portion of a SUM_FREQCOUNT table (denoted 700) for summarizing enhanced event data satisfying the specified criteria. In table 700, VAL_0 field 703 registers the number of information assistance calls accrued during the specified time period, each of which has no enhanced event satisfying the specified criteria therein; VAL_1 field 705 registers the number of information assistance calls accrued during the specified time period, each of which has only one enhanced event satisfying the specified criteria therein; VAL_2 field 707 registers the number of information assistance calls accrued during the specified time period, each of which has two enhanced events satisfying the specified criteria therein; VAL_3 field 709 registers the number of information assistance calls accrued during the specified time period, each of which has three enhanced events satisfying the specified criteria therein; and VAL_4+ field 711 registers the number of information assistance calls accrued during the specified time period, each of which has four or more enhanced events satisfying the specified criteria therein.

In order to fully appreciate the methodology for developing the summarization data portion of table 700, an accessory table used in such a methodology will now be described. FIG. 8 illustrates such an accessory table (denoted 800), which tabulates the number of enhanced events occurring in each qualified information assistance call identified by its CCSN. To that end, table 800 accommodates pairs of CCSN and NUM_ENHANCED_EVENTS (NEE) values in rows. In each row, a CCSN identifies a qualified assistance information call, and the associated NEE value represents the number of enhanced events occurring in the qualified information assistance call.

FIG. 9 illustrates routine 900 for generating the summarization data portion of table 700 and developing table 800 in the process. Instructed by routine 900, computer 334 selects from all event records those satisfying the specified criteria described above. For each selected record, computer 334 further determines whether the selected record is associated with a “existing” or “new” information assistance call, and whether the recorded event is an enhanced event or not. An information assistance call is said to be new when computer 334 first encounters the CCSN value in the selected record identifying such a call. Specifically, for each selected record, computer 334 at step 903 determines whether the CCSN value in the selected record matches any CCSN value in CCSN column 803 in accessory table 800. If there is no match, the information assistance call associated with the selected record is considered new. In that case, computer 334 at step 906 adds the CCSN value in the selected record to CCSN column 803. Routine 900 then proceeds to step 909 where computer 334 determines whether the event represented by the selected record is an enhanced event. In such a determination, computer 334 checks the pair of values of EVENT_CLASS_ID field 211 and EVENT_TYPE_ID field 247 of the selected record against a pre-set list of EVENT_CLASS_ID and EVENT_TYPE_ID value pairs, which identify predetermined enhanced events. Only if the value pair of the selected event record matches one of the value pairs in the pre-set list, should the event represented by the selected record be designated an enhanced event. In that case, computer 334 enters a count “1” in NEE column 805 of accessory table 800 next to the CCSN value just added, as indicated at step 912. In addition, computer 334 at step 915 increments the value of VAL_1 field 703 in table 700 by one as a new call with an enhanced event occurrence has been identified. It should be noted that VAL_0, VAL_1, VAL_2, VAL_3 and VAL_4+fields 703, 705, 707, 709 and 711 of table 700 are initially set to zero.

Returning to step 909, if it is determined that the event represented by the selected record is not an enhanced event, computer 334 at step 918 increments the value of VAL_0 field in table 700 by one as a new call with no enhanced event occurrence has been identified.

Returning to step 903, if the CSSN value in the selected record is not new, i.e., the CSSN value in question matches one of the CSSN values in column 803, computer 334 at step 921 determines whether the event represented by the selected record is an enhanced event. If it is not, computer 334 at step 922 ignores the selected record as the latter has no effect on field 703, 705, 707, 709 or 711. Otherwise, if it is determined that the subject event is an enhanced event, computer may need to modify the summarization data in one or more of fields 703, 705, 707, 709 and 711 to reflect an increase in the number of enhanced events occurring in a call which has been taken into account. To that end, computer 334 at step 924 increments the NEE value in table 800 associated with the CSSN value in question by one, resulting in a new NEE value=K, where K represents an integer greater than zero. Computer 334 determines at step 927 whether 0<K<4. If that is the case, computer 334 at step 931 increments the value of VAL_K field of table 700 by one, and at step 934 decrements the value of VAL_(K−1) field by one.

Otherwise, if K≧4, computer 334 determines whether K=4, as indicated at step 937. If that is the case, computer 334 at step 941 increments the value of VAL_4+ field 711 of table 700 by one, and at step 943 decrements the value of VAL_3 field 709 by one. Otherwise, if K>4, computer 334 at step 947 ignores the effect of the selected record as far as table 700 is concerned.

The foregoing merely illustrates the principles of the invention. It will thus be appreciated that those skilled in the art will be able to devise numerous other arrangements which embody the principles of the invention and are thus within its spirit and scope.

For example, in the disclosed embodiment, remote computer 334 is used to receive and process event data from various call centers. It will be appreciated that multiple remote computers similar to computer 334 may be geographically distributed to share the data load especially when the volumes of event data transmitted from the call centers are large. In that case, each remote computer sends, to the event monitor server in each call center, a feedback signal indicating its current load, thereby properly directing data traffic to those remote computers having a lesser load.

In addition, in the disclosed embodiment, remote computer 334 performs the function of analyzing and compiling statistics based on event data. In an alternative embodiment, such a function is distributed among call centers. For example, the event monitor servers in the call centers may respectively perform such a function on the event data generated from the centers, and the resulting statistical data is then transmitted from the respective centers to computer 334.

Finally, call center 10 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A system for conducting a communication comprising:
at least one device for realizing a plurality of events in the communication, the at least one device generating a plurality of records concerning the events, respectively, the records including data descriptive of the respective events, each record including an identifier identifying the communication; and
a server for processing the records before transmission thereof.

2. The system of claim 1 wherein the communication includes an information assistance call.

3. The system of claim 1 wherein the at least one device includes a switch subsystem for receiving the communication.

4. The system of claim 1 wherein the at least one device includes a voice response unit.

5. The system of claim 1 wherein at least one device includes a database subsystem for providing information assistance in the communication.

6. The system of claim 1 wherein at least one of the events includes a search for a telephone number.

7. The system of claim 1 wherein the at least one of the events includes a StarBack event.

8. The system of claim 1 wherein the data includes information identifying classes to which the respective events belong.

9. The system of claim 1 wherein the server compresses the data in the records before transmission thereof.

10. The system of claim 1 wherein the server controls a rate at which the records are transmitted.

11. The system of claim 1 wherein the server identifies selected records which are not to be transmitted.

12. The system of claim 1 wherein the server identifies priority statuses of the records and causes the records to be transmitted in an order pursuant to the priority statuses thereof.

13. The system of claim 12 wherein each of the priority statuses is indicated by a weight value relative to a predetermined weight value.

14. Apparatus for conducting a communication, the apparatus comprising:
an interface for receiving a plurality of records, each record being associated with a respective one of a plurality of events occurring during the communication, each record including at least an identifier identifying the communication;
a memory for storing a configuration file; and
a processor for processing the records based on a specification in the configuration file.

15. The apparatus of claim 14 wherein the records are transmissible, and the processor compresses data in the records before transmission thereof.

16. The apparatus of claim 15 wherein the specification includes a translation table, and the data is compressed by translating selected terms in the records to representations thereof in accordance with the translation table.

17. The apparatus of claim 14 wherein the records are transmissible, and the processor controls a rate at which the records are transmitted.

18. The apparatus of claim 17 wherein the specification includes a selected length of a time window, and the processor controls the rate based on a latency measure within the time window.

19. The apparatus of claim 14 wherein each record includes a plurality of fields, and the processor identifies selected records which are transmissible based on one or more values in a selected field of the selected records, the specification including the identity of the selected field and the one or more values.

20. The apparatus of claim 14 wherein the records are transmissible, and the processor identifies priority statuses of the records based on the specification, the processor causing the records to be transmitted in an order pursuant to the priority statuses thereof.

21. The apparatus of claim 20 wherein each record has a plurality of fields, the specification including an association of a priority value with at least one of the fields which has a selected value.

22. The apparatus of claim 21 wherein the priority value includes a weight value relative to a predetermined weight value.

23. A communications system for processing a call received in a call center where an operator provides services in the call, the communications system comprising:
at least one device for helping the operator to provide the services in the call, the at least one device generating a plurality of event records concerning the services, each event record including an identifier identifying the call;
a memory for storing a configuration file;
a first server for processing the event records in accordance with a specification in the configuration file; and
a second server for receiving the processed event records from the first server through a communications network, the second server generating a database including selected data from the received event records.

24. The system of claim 23 wherein the at least one device includes a switch subsystem for receiving the call.

25. The system of claim 23 wherein the at least one device includes a voice response unit.

26. The system of claim 23 wherein the at least one device includes a database subsystem for providing information assistance in the call.

27. The system of claim 23 wherein at least one of the services includes a search for a telephone number.

28. The system of claim 23 wherein the at least one of the services includes a StarBack service.

29. The system of claim 23 wherein the specification includes a translation table, and the first server translates selected terms in the event records to representations thereof in accordance with the translation table.

30. The system of claim 23 wherein the specification includes a selected length of a time window, and the first server controls a rate at which the event records are sent to the second server based on a latency measure within the time window.

31. The system of claim 23 wherein each event record includes a plurality of fields, selected event records being sent by the first server to the second server, the first server identifying the selected event records based on one or more values of a selected field in the selected event records, the specification including the identity of the selected field and the one or more values.

32. The system of claim 23 wherein the first server identifies priority statuses of the event records based on the specification, the first server causing the event records to be transmitted to the second server in an order pursuant to the priority statuses thereof.

33. The system of claim 32 wherein each event record has a plurality of fields, the specification including an association of a priority value with at least one of the fields which has a selected value.

34. The system of claim 23 wherein the first server causes the event records to be stored when a loss of a connection through the communications network is determined.

35. The system of claim 23 wherein the communications network includes a wide area network (WAN).

36. Apparatus for capturing events comprising:
an interface for receiving data concerning first events;
a processor for inserting the data into a database, and identifying second events based on selected data being inserted into the database; and
an output for generating records representing the second events.

37. The apparatus of claim 36 wherein the data includes identifiers identifying at least one class to which the first events belong.

38. The apparatus of claim 36 wherein the records include identifiers identifying at least one class to which the second events belong.

39. The apparatus of claim 36 wherein the first events concern outbound calls made from a call center, and the second events concern long distance connections made in the outbound calls.

40. The apparatus of claim 36 wherein the first events concern conference calls made through a call center, and the second events concern long distance connections made in the conference calls.

41. The apparatus of claim 36 wherein the first events concern outbound calls made from a call center, and the second events concern a selected service to which the outbound calls are connected.

42. The apparatus of claim 36 wherein the first events concern conference calls made through a call center, and the second events concern a selected service to which the conference calls are connected.

43. Apparatus for compiling statistics concerning at least one communication, the communication including a plurality of events occurring during the communication, the apparatus comprising:
an interface for receiving records representing the events, each record including an identifier;
a processor for associating selected records with the communication based on the identifiers in the selected records; and
an output for generating the statistics concerning the communication based on data in the selected records.

44. The apparatus of claim 43 wherein the communication includes an information assistance call.

45. The apparatus of claim 43 wherein the identifiers each identify the communication.

46. The apparatus of claim 43 wherein the statistics is a function of time when the communication takes place.

47. The apparatus of claim 43 wherein the statistics is a function of an interval during which the communication takes place.

48. The apparatus of claim 43 wherein the communication is conducted through a call center, and the statistics is a function of a location of the call center.

49. The apparatus of claim 43 wherein the communication is transported through a carrier, and the statistics is a function of the carrier.

50. The apparatus of claim 43 wherein the communication originates from a mark et, and the statistics is a function of the market.

51. The apparatus of claim 43 wherein the selected records are selected based on a type of event represented thereby.

52. The apparatus of claim 43 wherein the data includes indications of selected events represented by the selected records.

53. A method for use in a system for conducting a communication, the system including at least one device, the method comprising:
realizing by the at least one device a plurality of events in the communication;
generating by the at least one device a plurality of records concerning the events, respectively, the records including data descriptive of the respective events, each record including an identifier identifying the communication; and
processing the records before transmission thereof.

54. The method of claim 53 wherein the communication includes an information assistance call.

55. The method of claim 53 wherein at least one of the events includes a search for a telephone number.

56. The method of claim 53 wherein the at least one of the events includes a StarBack event.

57. The method of claim 53 wherein the data includes information identifying classes to which the respective events belong.

58. The method of claim 53 wherein the processing includes compressing the data in the records before transmission thereof.

59. The method of claim 53 wherein the processing includes controlling a rate at which the records are transmitted.

60. The method of claim 53 wherein the processing includes identifying selected records which are not to be transmitted.

61. The method of claim 53 wherein the processing includes identifying priority statuses of the records and causing the records to be transmitted in an order pursuant to the priority statuses thereof.

62. The method of claim 61 wherein each of the priority statuses is indicated by a weight value relative to a predetermined weight value.

63. A method for collecting information concerning a communication, the method comprising:
receiving a plurality of records, each record being associated with a respective one of a plurality of events occurring during the communication, each record including at least an identifier identifying the communication;
storing a configuration file; and
processing the records based on a specification in the configuration file.

64. The method of claim 63 wherein the records are transmissible, and the processing includes compressing data in the records before transmission thereof.

65. The method of claim 63 wherein the specification includes a translation table, and the data is compressed by translating selected terms in the records to representations thereof in accordance with the translation table.

66. The method of claim 63 wherein the records are transmissible, and the processing includes controlling a rate at which the records are transmitted.

67. The method of claim 66 wherein the specification includes a selected length of a time window, and the rate is controlled based on a latency measure within the time window.

68. The method of claim 63 wherein each record includes a plurality of fields, and the processing includes identifying selected records which are transmissible based on one or more values in a selected field of the selected records, the specification including the identity of the selected field and the one or more values.

69. The method of claim 63 wherein the records are transmissible, and the processing includes identifying priority statuses of the records based on the specification, and causing the records to be transmitted in an order pursuant to the priority statuses thereof.

70. The method of claim 69 wherein each record has a plurality of fields, the specification including an association of a priority value with at least one of the fields which has a selected value.

71. The method of claim 70 wherein the priority value includes a weight value relative to a predetermined weight value.

72. A method for use in a communications system for processing a call received in a call center where an operator provides services in the call, the communications system including at least one device, the method comprising:
using the at least one device to help provide the services in the call;
generating by the at least one device a plurality of event records concerning the services, each event record including an identifier identifying the call;
storing a configuration file;
processing the event records in accordance with a specification in the configuration file;
receiving the processed event records through a communications network; and
generating a database which includes selected data from the received event records.

73. The method of claim 72 wherein at least one of the services includes a search for a telephone number.

74. The method of claim 72 wherein the at least one of the services includes a StarBack service.

75. The method of claim 72 wherein the specification includes a translation table, and the processing includes translating selected terms in the event records to representations thereof in accordance with the translation table.

76. The method of claim 72 wherein the specification includes a selected length of a time window, and the processing includes controlling a rate at which the event records are transmitted through the communications network based on a latency measure within the time window.

77. The method of claim 72 wherein each event record includes a plurality of fields, selected event records being transmitted through the communications network, the processing including identifying the selected event records based on one or more values of a selected field in the selected event records, the specification including the identity of the selected field and the one or more values.

78. The method of claim 72 wherein the processing includes identifying priority statuses of the event records based on the specification, and causing the event records to be transmitted through the communications network in an order pursuant to the priority statuses thereof.

79. The method of claim 78 wherein each event record has a plurality of fields, the specification including an association of a priority value with at least one of the fields which has a selected value.

80. The method of claim 72 wherein the processing includes storing the event records when a loss of a connection through the communications network is determined.

81. A method for capturing events comprising:
receiving data concerning first events;
inserting the data into a database;
identifying second events based on selected data being inserted into the database; and
generating records representing the second events.

82. The method of claim 81 wherein the data includes identifiers identifying at least one class to which the first events belong.

83. The method of claim 81 wherein the records include identifiers identifying at least one class to which the second events belong.

84. The method of claim 81 wherein the first events concern outbound calls made from a call center, and the second events concern long distance connections made in the outbound calls.

85. The method of claim 81 wherein the first events concern conference calls made through a call center, and the second events concern long distance connections made in the conference calls.

86. The method of claim 81 wherein the first events concern outbound calls made from a call center, and the second events concern a selected service to which the outbound calls are connected.

87. The method of claim 81 wherein the first events concern conference calls made through a call center, and the second events concern a selected service to which the conference calls are connected.

88. A method for compiling statistics concerning at least one communication, the communication including a plurality of events occurring during the communication, the method comprising:
receiving records representing the events, each record including an identifier;
associating selected records with the communication based on the identifiers in the selected records; and
generating the statistics concerning the communication based on data in the selected records.

89. The method of claim 88 wherein the communication includes an information assistance call.

90. The method of claim 88 wherein the identifiers each identify the communication.

91. The method of claim 88 wherein the statistics is a function of time when the communication takes place.

92. The method of claim 88 wherein the statistics is a function of an interval during which the communication takes place.

93. The method of claim 88 wherein the communication is conducted through a call center, and the statistics is a function of a location of the call center.

94. The method of claim 88 wherein the communication is transported through a carrier, and the statistics is a function of the carrier.

95. The method of claim 88 wherein the communication originates from a market, and the statistics is a function of the market.

96. The method of claim 88 wherein the selected records are selected based on a type of event represented thereby.

97. The method of claim 88 wherein the data includes indications of selected events represented by the selected records.
